(19) United States
(12) Patent Application Publication
(10) Pub. No.: US 2012/0252336 A1
(43) Pub. Date: Oct. 4, 2012

(54) Apparatus And Method For Separating Soft And Solid Components Of Food

(76) Inventor: James Haythornthwaite, Hudson (CA)

(21) Appl. No.: 13/435,324

(22) Filed: Mar. 30, 2012

(30) Foreign Application Priority Data
Apr. 1, 2011 (CA) 2735574

(51) Int. Cl. A22C 17/00

(52) U.S. Cl. 452/135

(57) ABSTRACT

Method and apparatus for separating meat and bone. The apparatus separator comprises a rotating cutting head defining a rotary axis; a flexible cutting means attached to the rotating cutting head and rotating about the rotary axis, and defining a cutting plane; a transport means for transporting a bone with meat pieces to the cutting plane; wherein the flexible cutting means follows contours of the bone and separates the meat pieces from the bone.

This application is related to and claims priority from Canadian Application 2,735,574, filed on Apr. 1, 2011, entitled “Apparatus And Method For Separating Soft And Solid Components Of Food” by James Haythornthwaite, the entire disclosure of which is hereby incorporated by reference for all purposes as if fully set forth herein.

### FIELD OF THE INVENTION

The present invention relates to an apparatus and method for separating food material with different degrees of hardness, more specifically, the present invention relates to an apparatus and method for separating meat from bones.

### BACKGROUND OF THE INVENTION

An automated removal of meat from a bone poses special problems. For example, meat has a tendency to adhere to the bone and the removal thereof necessitates a tearing or shearing of the meat from the bone.

For example, U.S. Pat. No. 5,749,776 describes a meat deboning apparatus of the horizontally-arranged type, which is linear in a horizontal plane and supported by a base; and U.S. Pat. No. 6,354,933 describes an apparatus for deboning a piece of meat with an elongated bone, such as a loin piece provided with a spine.

Other approaches taken in the prior art involve the use of multiple blades for stripping the meat from the bone. U.S. Pat. Nos. 3,261,054, 3,402,423 and 3,457,586, for example, utilize stripping blades which are biased against the surface of the bone to remove the meat from the bone. U.S. Pat. No. 1,435,877 is a boning device with sharp blades which are rotatable around the bone to remove the meat therefrom. In this latter device, the tips of the knife-like blades form an opening to accommodate the bone which opening must be manually adjusted by the operator according to his best guess as to where the knuckle enlargement is located within the meat.

In general, the prior art devices have not been entirely satisfactory since they have been heavy, complex, cumbersome with high initial cost, difficult to manufacture and maintain, have high possibility of bone chippings for scrapings being mixed with the meat, leaving meat residuals on the bone, and for other reasons have not been acceptable for the purpose intended.

Therefore, there is a need for an effective method and apparatus to separate the meat from the bones.

### SUMMARY OF THE INVENTION

Aspects of the present invention are directed to an apparatus and method for separating meat from bone.

In one aspect, in accordance with one embodiment of the present invention, there is provided an apparatus, a meat and bone separator. The separator comprises a rotating cutting head defining a rotary axis, a flexible cutting means attached to the rotating cutting head and rotating about the rotary axis, and defining a cutting plane; and a transport means for transporting a bone with meat pieces to the cutting plane. The flexible cutting means follows contours of the bone and separates the meat pieces from the bone.

In some embodiments, the meat and bone separator further comprises a plurality of rotating cutting heads.

In some embodiments, the plurality of rotating cutting heads defines a plurality of cutting planes, and the plurality of cutting planes is at different heights.

In some embodiments, the plurality rotating cutting heads rotates in different directions.

In some embodiments, the meat and bone separator further comprises a cutting box for housing the rotating cutting head.

In some embodiments, the meat and bone separator further comprises a collection box for receiving the separated meat pieces.

In some embodiments, the transport means comprises an endless belt.

In some embodiments, the cutting plane is parallel to the endless belt.

In some embodiments, the meat and bone separator further comprises an automatic continuous height adjusting means.

In some embodiments, the automatic continuous height adjusting means comprises a cam and a compression spring.

In some embodiments, the collection box further comprises suction means for facilitating collecting meat pieces.

In some embodiments, the collection box further comprises slots for receiving the meat pieces.

In some embodiments, the cutting box further comprises air blowing means.

In accordance with another aspect of the invention, there is provided a method of separating meat pieces from a bone. The method comprises the steps of: rotating a cutting head about a rotary axis; the cutting head having a flexible cutting means attached, and defining a cutting plane; transporting a bone with meat pieces to the cutting plane; causing the flexible cutting means to follow contours of the bone; and separating the meat pieces from the bone.

In some embodiments, the flexible cutting means comprises a flexible cutting blade.

In some embodiments, wherein the flexible cutting means comprises a string.

In some embodiments, the string is a nylon string.

In some embodiments, the string is a stainless steel string.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a perspective view of a bone and meat separator in accordance with one embodiment of the present invention;

FIG. 2 is a sectional view of a cutting box in accordance with one embodiment of the present invention;

FIG. 3 shows an exemplary embodiment of a flexible cutting head with flexible cutting blades;

FIG. 4 shows another embodiment of a flexible cutting head with strings;

FIG. 5 is a sectional view of a cutting box in accordance with another embodiment of the present invention;

FIG. 6 is a sectional view of a cutting box in accordance with another embodiment of the present invention;

FIG. 7 illustrates an arrangement of the flexible cutting heads;

FIG. 8 shows an automatic continuous height adjustment means of a flexible cutting head;

FIG. 9 is sectional view of a cutting box and a collection box, showing the air flow in this arrangement; and

FIG. 10 is a top view of a collection box.

### DETAILED DESCRIPTION OF PREFERRED EMBODIMENTS

Reference will now be made in detail to some specific embodiments of the invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known process operations have not been described in detail in order not to unnecessarily obscure the present invention.

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art to which this invention belongs.

Although the terms “meat” and “bone” are used throughout the disclosure, it should be apparent to a person skilled in the art that the method and apparatus described herein applies in general to food material with different degrees of hardness. Furthermore, the meat and bones are intended to include meat and bones originated from any vertebrate animals, for example but not limited to, fish.

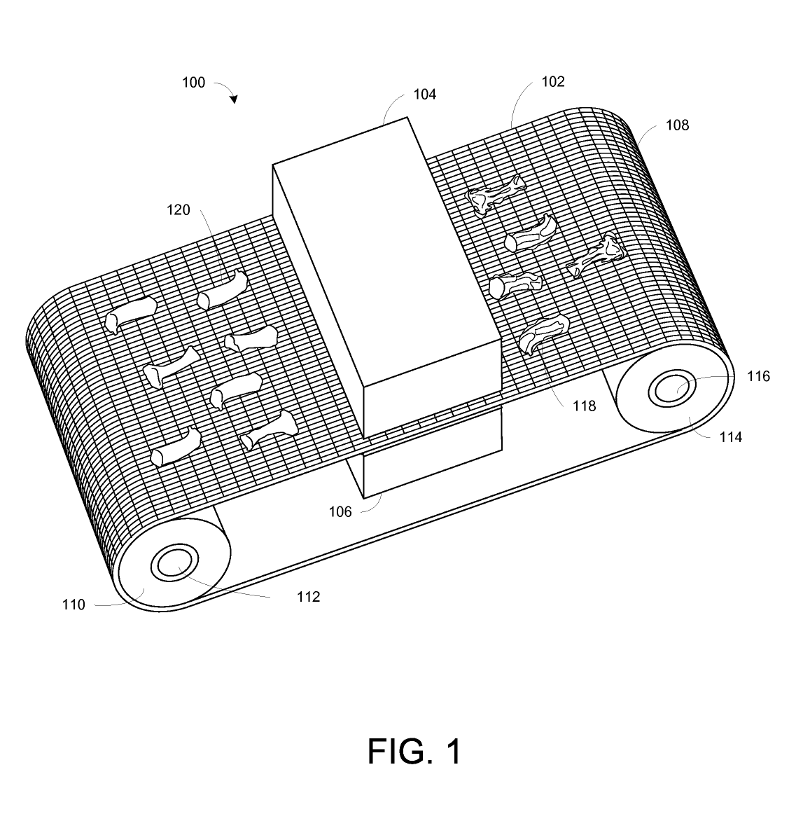

Referring to FIG. 1, a first preferred embodiment of a bone and meat separator according to the present invention will now be described in detail. The bone and meat separator generally designated as 100 comprises a transport means, for example, a conveyor 102, a cutting box 104 and a collection box 106.

The conveyor 102 includes an endless belt 108 located on a frame or any other fixing means (not shown). The belt 108 extends between a first roller 110 mounted on a rotating driven shaft 112 and a second roller 114 freely rotatable on a shaft 116 which can be adjusted to tension the belt 102.

The endless belt 108 generally comprises perforations which allow the meat pieces, after being removed from the bone, to fall therethrough. Preferably, the endless belt 108 is a mesh belt. Preferably, the mesh belt is made from metal, composite material or other suitable material.

When a piece of bone 118 having meat clinging thereto is moved on the endless belt 108 through the cutting box 104, the meat will be removed, as will be described below. The removed meat will be collected in the collection box 106 through gravity or, preferably, through a suction originated in the collection box 106, or an air blow generated in the cutting box 104. The air flow in the direction from the cutting box 104 to the collection box 106 aids the removal of the meat pieces from the belt 108.

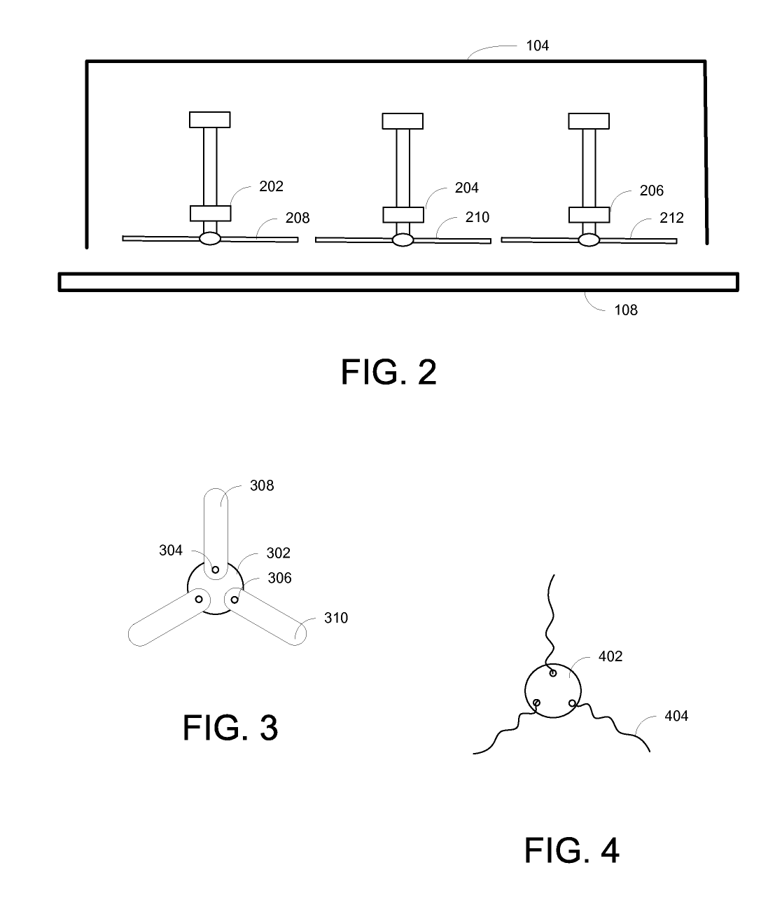

Referring to FIG. 2, in accordance with one embodiment of the present application, the cutting box 104 includes one or more rotating cutting head 202, 204, 206. The cutting head 202, 204, 206 use flexible cutting means 208, 210, 212, for example, a metallic string such as a stainless steel string or a non-metallic string such as a nylon string, or a plurality of flexible cutting blades rotating at a rate suitable for removing meat from the bone. The non-metallic string may be a nylon string.

FIG. 3 shows an exemplary embodiment of the flexible cutting means 208, 210, 212 where a rotatable disc 302 is provided with a plurality of retaining means 304, 306, for example, screws, for attaching a plurality of flexible cutting means, for example, cutting blades 308, 310 to the rotatable disc 302. In general, the cutting blades 308, 310 are freely rotatable about the retaining means 304, 306.

FIG. 4 shows another embodiment of the flexible cutting means 208, 210, 212 where a plurality of strings, for example but not limited to, stainless steel, composite, or nylon strings are attached to the rotatable disc 402. Embodiments in FIG. 3 and FIG. 4 have three, evenly-spaced flexible cutting means, but embodiments with other numbers may be effective.

In operation, the centrifugal force of rotation tends to maintain the flexible cutting means in a fully extended attitude in a cutting plane perpendicular to the axis of rotation. When a bone with meat pieces attached is transported on the belt 108 through the one or more flexible cutting means 208, 210, 212, for example, stainless steel or nylon strings or cutting blades. The flexible cutting edges of the flexible cutting means 208, 210, 212 follow the contours of the bone and remove the meat pieces from bone.

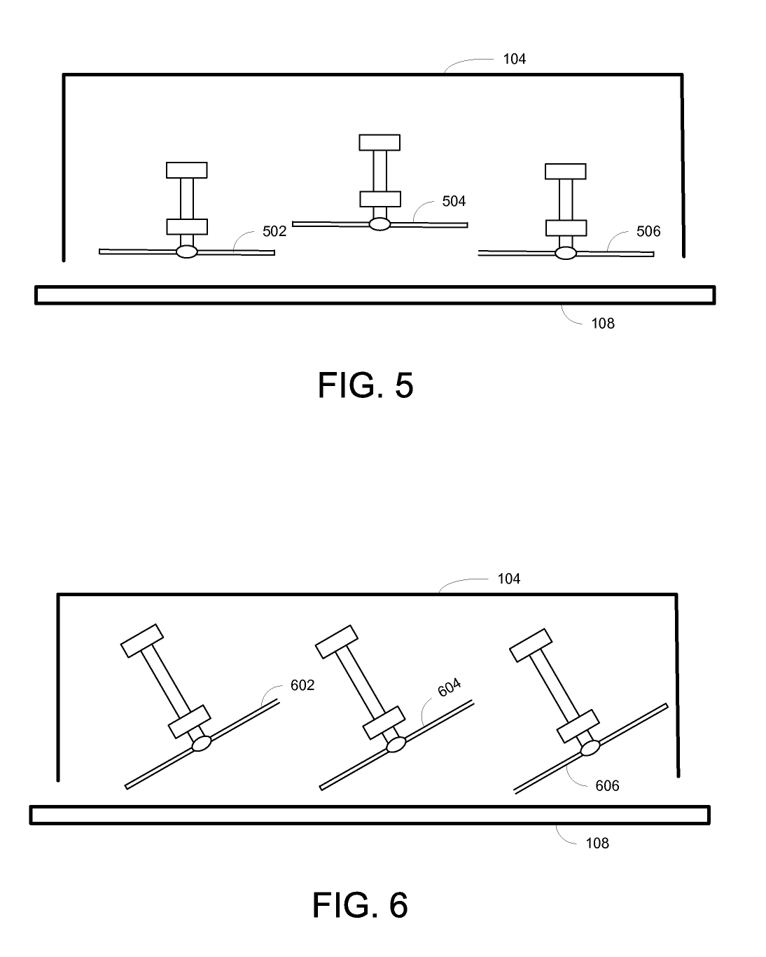

In FIG. 2, the cutting planes defined by the respective flexible cutting means 208, 210, 212 are in the same plane and are generally parallel the surface of the belt 108. FIGS. 5 and 6 illustrate two additional embodiments. The cutting planes defined by flexible cutting means 502, 504 and 506 in FIG. 5 are offset with each other in relation to the belt 108.

In FIG. 6, the cutting planes 602, 604 and 606 form an angle with the belt 108. This arrangement may have the advantage that when a bone is moving towards the flexible cutting means, meat pieces at different heights on the bone may come more easily in contact with the cutting edges, thus providing a more efficient removal.

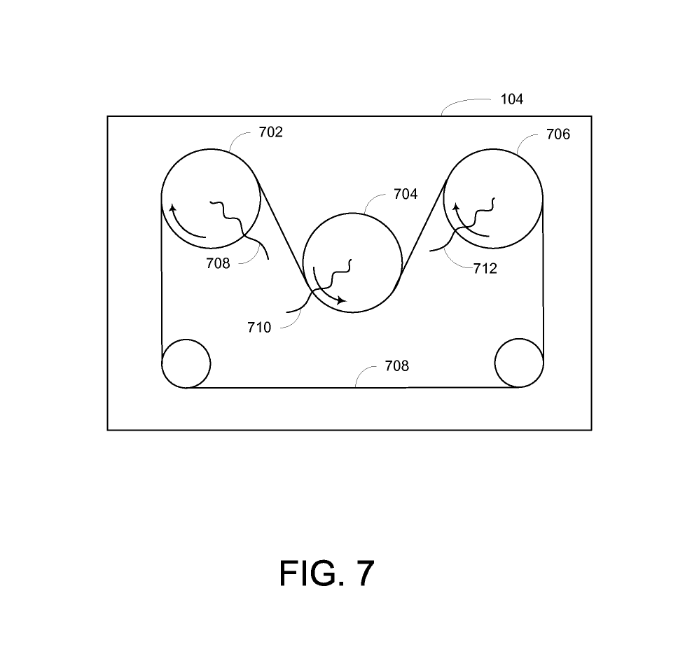

It should be apparent to a person skilled in the art that the flexible cutting means may be driven by proper power means. FIG. 7 illustrates an arrangement of the flexible cutting means 702, 704, 706 in accordance with one embodiment of the present invention with a top view of the cutting box 104. In this arrangement, the flexible cutting means 702, 704, 706 are driven by a belt 708, and arranged as such that the flexible cutting means 702 and 706 rotate clockwise, and the flexible cutting means 704 rotates anticlockwise when viewed from above. The flexible cutting means 702, 704, 706, for example but not limited to, strings 708, 710, 712 or flexible cutting heads, are arranged to overlap the path through which the bones on the belt 108 travel.

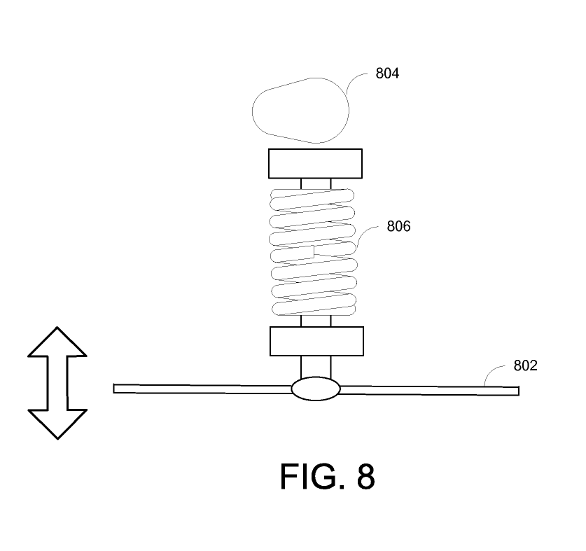

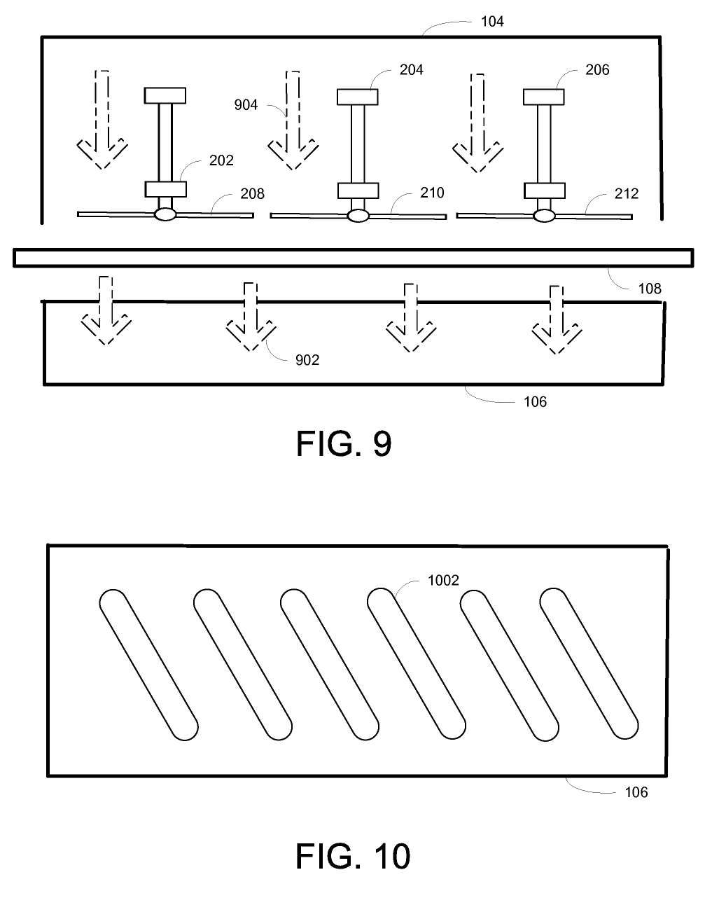

The distance between the cutting planes defined by the flexible cutting means and the belt may also be adjusted, both to accommodate the various sizes of the bones and to adjust the heights of the cutting edges in relation to a bone while the meat pieces are removed from the bone. Referring to FIG. 8, the cutting plane 802 defined by the flexible cutting means may be adjusted through an exemplary embodiment as illustrated, an automatic continuous height adjustment means, for example but not limited to, a cam 804, in combination with a compression spring 806 lowers and lifts the flexible cutting means 802, depending on the rotational position of the cam 804.

The separation of the meat removed from the bone may further be aided by an air flow from the cutting box 104 to the collection box 106. The collection box 106, in one preferred embodiment, may be implemented as a suction box creates an air flow 902 for facilitating the movement of the meat pieces from the belt with perforations to the collection box. In another embodiment, the cutting box 104 may generate an air flow 904 which blows the removed meat pieces towards the collection box 106.

FIG. 10 is a top view of the collection box 106, in this embodiment, a plurality of slots 1002 is provided. It should apparent to a person skilled in the art that the size of the slots depends on the meat being separated from bone.

The present invention has been described with regard to one or more embodiments. However, it will be apparent to persons skilled in the art that a number of variations and modifications can be made without departing from the scope of the invention as defined in the claim.

What is claimed is:

1. A meat and bone separator comprising:
a rotating cutting head defining a rotary axis;
a flexible cutting means attached to the rotating cutting head and rotating about the rotary axis, and defining a cutting plane; and
a transport means for transporting a bone with meat pieces to the cutting plane;
wherein the flexible cutting means follows contours of the bone and separates the meat pieces from the bone.

2. The meat and bone separator according to claim 1, further comprising a plurality of rotating cutting heads.

3. The meat and bone separator according to claim 1, further comprising a cutting box for housing the rotating cutting head.

4. The meat and bone separator according to claim 1, further comprising a collection box for receiving the separated meat pieces.

5. The meat and bone separator according to claim 1, wherein the flexible cutting means comprises a flexible cutting blade.

6. The meat and bone separator according to claim 1, wherein the flexible cutting means comprises a string.

7. The meat and bone separator according to claim 6, wherein the string is a nylon string.

8. The meat and bone separator according to claim 6, wherein the string is a stainless steel string.

9. The meat and bone separator according to claim 1, wherein the transport means comprises an endless belt.

10. The meat and bone separator according to claim 7, wherein the cutting plane is parallel to the endless belt.

11. The meat and bone separator according to claim 2, wherein the plurality of rotating cutting heads defines a plurality of cutting planes, and the plurality of cutting planes is at different heights.

12. The meat and bone separator according to claim 2, wherein the plurality rotating cutting heads rotates in different directions.

13. The meat and bone separator according to claim 1, further comprising an automatic continuous height adjusting means.

14. The meat and bone separator according to claim 11, wherein the automatic continuous height adjusting means comprises a cam and a compression spring.

15. The meat and bone separator according to claim 4, wherein the collection box further comprises suction means for facilitating collecting meat pieces.

16. The meat and bone separator according to claim 4, wherein the collection box further comprises slots for receiving the meat pieces.

17. The meat and bone separator according to claim 3, wherein the cutting box further comprises air blowing means.

18. A method of separating meat pieces from a bone, comprising the steps of:
rotating a cutting head about a rotary axis; the cutting head having a flexible cutting means attached, and defining a cutting plane;
transporting a bone with meat pieces to the cutting plane;
causing the flexible cutting means to follow contours of the bone; and
separating the meat pieces from the bone.
